(19) United States
(12) Patent Application Publication
(10) Pub. No.: US 2007/0094209 A1
(43) Pub. Date: Apr. 26, 2007

(54) Cause and effect problem solving system and method

(76) Inventors: Donald V. Steward, Napa, CA (US); Stuart Williams, Fair Oaks, CA (US)

Correspondence Address: Dergosits & Noah LLP, Suite 1450, Four Embarcadero Center, San Francisco, CA, 94111, US

(21) Appl. No.: 11/521,801

(22) Filed: Sep. 15, 2006

Related U.S. Application Data
(63) Continuation-in-part of application No. 10/264,437, filed on Oct. 3, 2002.

(51) Int. Cl. G06F 17/00

(52) U.S. Cl. 706/49

(57) ABSTRACT

The invention comprises methods for describing a system using sets of cause and effect statements. Elimination of intermediate effects then reveals all the explanations for the observed or desired behaviors in polynomial computing time. As can be appreciated, that behavior is described by Boolean expressions on the effects and the explanations are expressed in terms of all the hypotheses stated as Boolean expressions on the primary causes. Correspondingly, these methods find all the explanations consistent with the scope of the set of cause and effect relations. The invention also comprises data processing systems programmed to apply the methods to such applications as generating/predicting all the consequences of each hypothesis to identify side effects, implementing the causes to produce desired effects, and constructing inventions by selecting from appropriate capabilities.

### CROSS-REFERENCE TO RELATED APPLICATIONS

This application is a continuation-in-part of U.S. patent application Ser. No. 10/264,437, filed Oct. 3, 2002, which is hereby incorporated by reference in its entirety.

### FIELD OF THE PRESENT INVENTION

The present invention relates generally to systems and methods for solving problems comprising complex combinations of cause and effect relationships. More particularly, the invention relates to a system and method for eliminating intermediate cause and effect relations from a closed system of Boolean expressions to solve problems abductively in order to find hypotheses that explain behaviors of systems that are described by sets of cause and effect relations.

### BACKGROUND OF THE INVENTION

Conventional expert systems have found many practical applications in customer service and to provide professional training and expertise to general practitioners in various fields. However, they are primarily of limited applicability, being limited to well understood and characterized systems where the expertise has been generated by significant experimentation or observations or experience acquired over time.

Prior methods of developing and using expert systems for the solving or diagnosis of problems required an expert to develop a logical structure that would generate a series of queries wherein the answers to each query would select additional queries, until the software develops the conclusions similar to those that could be reached by analogy to how an expert would reach his or her conclusions. Thus, using conventional expert systems requires guessing the controllable and assumed causes of specified observable effects based on the judgments of an existing expert or experts without recourse to understanding the unobservable primitive mechanisms that explain the behavior.

Indeed, users of prior expert systems may not know the assumptions used by the expert in formulating the model and may be inclined to use the model under circumstances where those assumptions are not satisfied.

Furthermore, to develop an expert system requires an expert who can construct the structure of the query logic in a manner where each query predictably leads to the ultimate result. However, in reality there are indeed few experts in relation to all the existing complex systems for which one would like to have diagnostic methods, be the systems naturally occurring or man-made or designed.

For example, U.S. Pat. No. 5,018,075 to Hayden et al. discloses the formation of an expert system. As described above, this relies on external knowledge from observing how a system behaves as a whole rather than using internal knowledge which may come from a number of people about how various aspects and parts of the system work, which taken together would explain the behavior of the system as a whole.

Because prior methods of developing and using expert systems do not rely on the underlying mechanisms of primitive cause and effect relations, they are limited in the questions that can be asked of them to those anticipated by the expert. Similarly, conventional expert systems cannot be easily modified with new knowledge introduced by anyone other than the original expert.

When designing a system for solving problems, there are generally two reasoning frameworks available. Most conventional expert systems utilize a strategy of deduction wherein a particular hypothesis of causes is given and the system attempts to predict the effects, or the behavior produced by the causes. For example, U.S. Pat. No. 6,448,982 to Klapper discloses a system using Boolean expression to determine the possible effects given a sequence of known causes, thus using a conventional deduction strategy

Similarly, U.S. Pat. No. 5,406,477 to Harhen discloses the use of multiple predictive methods and reconciliation of the results. By using predictive method, this disclosure is limited to examining causes to determine effects deductively.

Further, U.S. Pat. No. 5,793,933 to Iwamasa describes a method of constructing hypothesis candidates by trial and error and testing them by deduction to eliminate those that do not meet the desired criteria.

However, it can often be advantageous to start with an observed or desired behavior or effect, and determine all possible hypotheses made up of combinations of primary causes that would lead to that behavior. This logical framework can be described as abductive. For each cause, both true and false conditions must be considered. Furthermore, there is also the potential that whether the cause is true or false does not affect the desired effect, in which case this cause has the value of ‘Don't Care’.

As can be appreciated, problem solving using an abductive strategy can be significantly more complicated than deductive reasoning. The conventional method for abductive problem solving is to perform a deductive analysis for every possible combination of primary causes that could constitute a hypothesis and discard all hypotheses that do not predict the desired behavior.

The unfortunate consequence of these combinatorial problems is that the required number of steps increases exponentially with the number of primary causes considered. The number of steps required for searching through n possible primary causes, wherein each primary cause is considered to have either of two possible values, is 2ⁿ. Thus, for a system having 10 primary causes it would require about a thousand examinations of hypotheses, a system having 20 primary causes would require a million examinations, and a system having 40 primary causes would require a trillion examinations. As can be seen, this approach rapidly becomes impractical when dealing with systems having any appreciable number of primary causes.

Accordingly, it is an object of the invention to solve systems of cause and effect relations to find all the valid hypotheses within the scope of said system of cause and effect relations that will explain behavior that is observed or desired.

### SUMMARY OF THE INVENTION

In accordance with the above objects and those that will be mentioned and will become apparent below, the invention includes a method for solving a problem comprising the steps of providing a closed system of a plurality of cause and effect statements, wherein the plurality of statements exhibit equivalency relationships and wherein the plurality of statements comprise primary causes, intermediate effects and at least one desired effect, expressing the desired effect as true or false in relationship to the primary causes and intermediate effects, representing the plurality of cause and effect statements as a plurality of simultaneous Boolean expressions, simplifying the simultaneous Boolean expressions by substituting expressions using primary causes to eliminate expressions using intermediate effects, and expressing the desired effect as true or false in relation only to the primary causes.

In one embodiment of the invention, the step of simplifying the simultaneous Boolean expressions comprises identifying a cluster of identical Boolean operators within the expressions that comprise the intermediate effects and replacing the cluster with a single Boolean operator. Preferably, the step of simplifying the simultaneous Boolean expressions comprises identifying a plurality of clusters of identical Boolean operators within the expressions that comprise the intermediate effects and replacing the cluster with a single Boolean operator, wherein each cluster comprises either AND and NOT operators or OR and NOT operators. Also preferably, the step of simplifying the simultaneous Boolean expressions further comprises implementing NOT operators by, in the effect to cause direction, by changing each AND operator to an OR operator, changing each OR operator to an AND operator, adding a NOT operator if one does not exist, and removing a NOT operator if one does exist.

In the noted embodiment of the invention, the step of expressing the desired effect as true or false in relation only to the primary causes can further comprise identifying and removing redundancies with Boolean algebra.

In another embodiment of the invention, the step of simplifying the simultaneous Boolean expressions comprises substituting into an expression comprising an intermediate effect an expression comprising only primary causes. Preferably, the method further comprises the step of removing any redundancies after substituting an expression comprising only primary causes for an expression comprising an intermediate effect. Also preferably, the method further comprises the step of performing a subsequent substitution of an expression comprising an intermediate effect with an expression comprising only primary causes.

In one aspect of the invention, the step of expressing the desired effect as true or false in relation only to the primary causes identifies all hypotheses expressed by primary causes that lead to the desired effect in the closed system.

The invention also includes a data processing system comprising a memory containing a closed system of a plurality of cause and effect statements, wherein the plurality of statements exhibit equivalency relationships and wherein the plurality of statements comprise primary causes, intermediate effects and at least one desired effect, wherein the plurality of cause and effect statements are represented as a plurality of simultaneous Boolean expressions and wherein the desired effect is expressed as true or false in relationship to the primary causes and intermediate effects, and an abducing processor configured to simplify the simultaneous Boolean expressions by substituting expressions using primary causes to eliminate intermediate effects and express the desired effect as true or false in relation only to hypotheses expressed by primary causes.

Preferably, the abducing processor is configured to identify a cluster of identical Boolean operators within the expressions that comprise the intermediate effects and replace the cluster with a single Boolean operator. In the noted embodiment, the abducing processor is preferably configured to identify a plurality of clusters of identical Boolean operators within the expressions that comprise the intermediate effects and replace the cluster with a single Boolean operator, wherein each cluster comprises either AND operators or OR operators. Also preferably, the abducing processor is configured to identify and remove redundancies with Boolean algebra.

Alternatively, the abducing processor is configured to identify a plurality of clusters containing either only ANDs and NOTs, or clusters containing only ORs and NOTs. Each cluster is replaced respectively by a single AND operator with NOTs or a single OR operator with NOTs. When a NOT is encountered its consequences are determined by applying De Morgan's theorem and its consequent effects propagated all the way through the intermediate effects to its ultimate effects on the primary causes.

In another aspect of the invention, the abducing processor is configured to substitute into an expression comprising an intermediate effect an expression comprising only primary causes. Preferably, the abducing processor is further configured to remove any redundancies after substituting an expression comprising only primary causes for an expression comprising an intermediate effect. Also preferably, the abducing processor is further configured to perform a subsequent substitution into an expression comprising an intermediate effect with an expression comprising only primary causes.

In the noted embodiments of the invention, the abducing processor can be configured to express the desired effect as true or false in relation only to the primary causes. In another embodiment of the invention, the abducing processor is configured to identify all the primary causes that lead to the desired effect in the closed system.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is a diagram of a simplified cause and effect system;

FIG. 2 is a representation of a plurality of cause and effect statements comprising the system shown in FIG. 1;

FIG. 3 is a representation of a plurality of cause and effect statements describing another system, including primary causes, intermediate effects and a desired effect, according to the invention;

FIGS. 4-10 are diagrams of cause and effect statements shown in FIG. 3, according to the invention;

FIGS. 11-15 are diagrams of an equation comprising the cause and effect statements of FIGS. 4-10 being simplified according to the invention; and

FIGS. 16 and 17 are diagrams of process involving substitution of Boolean expression of cause and effect statements; according to the invention.

### DETAILED DESCRIPTION OF THE INVENTION

Before describing the present invention in detail, it is to be understood that this invention is not limited to particularly exemplified materials, methods or structures as such may, of course, vary. Thus, although a number of materials and methods similar or equivalent to those described herein can be used in the practice of the present invention, the preferred materials and methods are described herein.

It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Further, all publications, patents and patent applications cited herein, whether supra or infra, are hereby incorporated by reference in their entirety.

Finally, as used in this specification and the appended claims, the singular forms “a, “an” and “the” include plural referents unless the content clearly dictates otherwise.

Generally, the invention comprises methods for describing a system using sets of cause and effect statements. Elimination of intermediate effects then reveals all the explanations for the observed or desired behaviors in polynomial computing time. For example, the invention includes a method that, given a set of cause and effect relations describing a system, is used to produce explanations of various behaviors of that system. As can be appreciated, that behavior is described by Boolean expressions on the effects and the explanations are expressed in terms of all the hypotheses stated as Boolean expressions on the primary causes. Correspondingly, this method finds all the explanations consistent with the scope of the set of cause and effect relations.

As described above, conventional expert systems match predetermined explanations with previously recognized symptoms. In contrast, the methods of this invention can generate explanations that may not have been predetermined for combinations of symptoms that may never have been recognized.

Generally, cause and effect statements consist of a Boolean combination of causes and a resulting effect. Effects from one cause and effect statement can become causes in other cause and effect statements. Primary causes are those causes that themselves have no other causes within the system. Hypotheses are composed of primary causes joined by ANDs. Alternate hypotheses are separated by ORs. Abduction is the process of inference to the best explanation, but can also mean generation of hypotheses to explain observations or conclusions.

Many types of systems can be described by sets of cause and effect relations so they can be analyzed by the method of this invention. For example, this method and apparatus can be used to make medical diagnoses, diagnose problems with various mechanisms such as cars, or various processes such as manufacturing processes, and find the causes of accidents or perpetrators of crimes.

As discussed above, the methods of the invention use elimination of intermediate effects to generate explanations in polynomial computing time. Cause and effect statements are then used to find the behaviors predicted by each hypothesis by deduction. These predicted behaviors can include side effects in addition to the desired effect. In one embodiment, those hypotheses that predict side effects deemed invalid are eliminated.

In one embodiment, the methods of the invention are implemented by a computing machine programmed with instructions for performing the abductive steps.

As will be discussed below, the methods of the invention deal with a closed system of a plurality of cause and effect statements, wherein the plurality of statements exhibit equivalency relationships and wherein the plurality of statements comprise primary causes, intermediate effects and at least one desired effect. The cause and effect statements are expressed using simultaneous Boolean expressions to allow the desired effect to be expressed as true or false in relationship to the primary causes and intermediate effects. In particular, the simultaneous Boolean expressions are simplified by substituting expressions of primary causes to eliminate expressions containing intermediate effects. Accordingly, the desired effect is then expressed as true or false in relation only to hypotheses composed of the primary causes.

The process consists of ordering the cause and effect statements so that each statement is preceded in the ordering by all those statements that produce the causes used in this statement. The causes are then substituted into the statements in order to obtain their resulting effects.

Solving the system of cause and effect statements produces all the hypotheses that would explain the object behavior without being concerned with the causes that do not impact the desired effect. However, such causes may impact side effects that are not part of the object behavior. Thus, one embodiment of the invention includes using the cause and effect statements to determine the consequences of each hypothesis to be able to reject all hypotheses that have side effects that are deemed to be false.

The same method can be used to find the hypotheses that would explain how some desired behavior of the system can be obtained by determining what hypotheses would explain that result and then bringing about the causes that make up that hypothesis.

Each cause and effect relation making up a description of a system may involve only a simple part or aspect of the system and hence involves only a small number of effects. As can be appreciated, this approach allows the combination of many simple relations without requiring an understanding of the whole system to the degree necessary to make a conventional expert system.

As one having skill in the art will appreciate, one consequence of the simplifying process of the invention is that it exhibits polynomial growth. For example, if it were assumed that the polynomial growth were quadratic, the number of steps can be expressed as n². Thus, a system comprising 40 primary causes can be solved by the method of this invention using 16 times the amount of computing time required for solving a system comprising 10 primary causes. The conventional abductive system exhibiting exponential growth described above for 40 primary causes would require a billion times the computing time required for solving a system comprising 10 primary causes.

As discussed above, the invention utilizes a closed system of cause and effect statements. Typically ‘implication,’ denoted as A B, is used to express cause and effect relations. However, this invention instead uses ‘equivalence,’ denoted as A=B. Generally, implication allows that if statement A is false, there could still be another cause from outside the system that makes the statement B True. Thus, implication is appropriate for an open system in which there is the possibility that a cause could come from outside the system being considered. On the other hand, equivalence is appropriate for the closed systems employed by the invention because if there were another cause for B, it would have to come from inside the system and thus be shown explicitly. A summary of the difference between implication and equivalence is expressed in Table 1.

TABLE 1

| IMPLICATION | | | EQUIVALENCE | | |
|---|---|---|---|---|---|
| A | B | A B | A | B | A = = B |
| T | T | T | T | T | T |
| T | F | F | T | F | F |
| F | T | T | F | T | F |
| F | F | T | F | F | T |

For example, if A causes B, then it can be said that if A occurs then B must occur or that A causes B. This is deduction. A causes B may be considered either an implication or an equivalence. If A causes B is considered to be an implication, then it is left open that there may be some other cause of B outside the system that has not been considered. Therefore, A would only be a possible explanation for B. However, if the system is closed, A causes B may be considered to be an equivalence where the only possible cause of B arises from a cause within the system that is explicitly stated.

The cause and effect relations of the system are discrete variables that can have the values of True, False, or Don't care. No cause and effect relations are allowed to have a cause that arises as a consequence of its effects, i.e., there can be no loops.

As discussed above, the invention utilizes a series of cause and effect statements represented as Boolean expressions. These expressions can be represented by a three level outline whereby level one is the effect, level two divides contiguous causes joined by ANDs by separating them with ORs, and level three are the causes joined by ANDs. In one embodiment, the statements are implemented using disjunctive canonical form. Alternatively, a conjunctive canonical form can also be used, whereby the roles of ANDs and ORs are effectively reversed. Yet another implementation may also use either disjunction or conjunctive canonical forms with level one being the causes and level three being the effects.

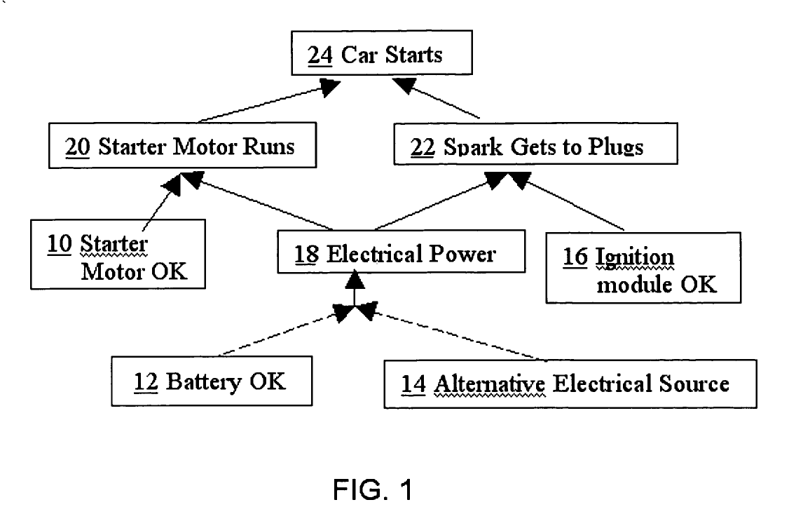

Turning now to FIG. 1, a diagram of a simplified cause and effect system relating to an automobile's starting system is illustrated. The four primary causes 10-16 are positioned towards the bottom of the diagram and have no causes leading to them. As can be seen, the solid arrows show causes that must be taken together, which correspond to the Boolean operator AND. Similarly, the dotted arrows show the causes that are alternatives, which correspond to the Boolean operator OR. Thus, Battery OK 12 and Alternative Energy Source 14 (such as an external battery) are shown as alternative causes for the intermediate effect of electrical power 18. Starter Motor OK 10 and Electrical Power 18 are causes required for the intermediate effect of Starter Motor Runs 20. Similarly, Ignition Module OK 16 and Electrical Power 18 are causes required for the intermediate effect of Spark Gets to Plugs 22. Finally, intermediate effects 18 through 22 are also causes required for the desired effect of the Car Starting 24.

Note that if the Starter Motor Runs 20 then there must be Electrical Power 18, which eliminates the lack of Electrical Power as a possible cause for NOT Spark Gets to Plugs 22. A full solution will show both those things that are wrong and those that are right. For diagnostic purposes, it can be desirable to exclude the elements that are not at fault.

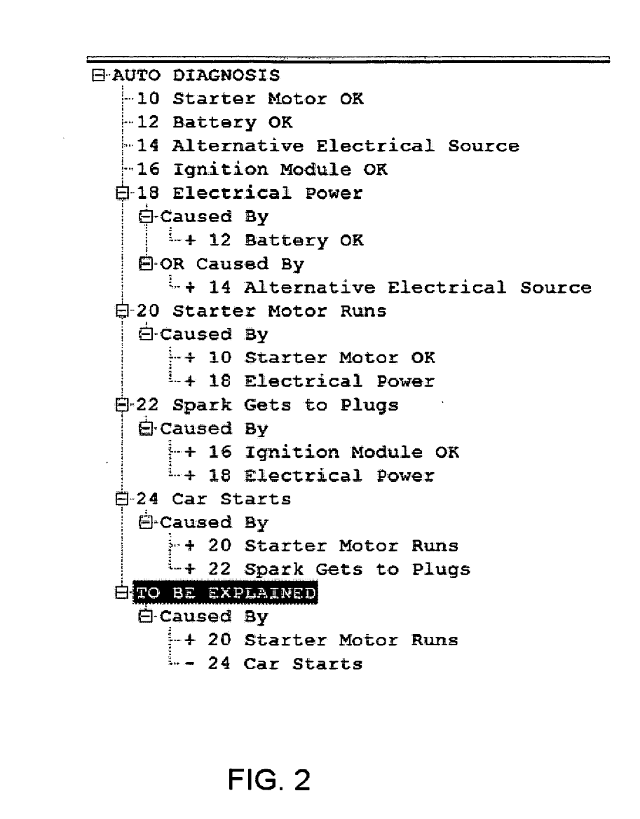

FIG. 2 shows a representation of how this information can be entered as a series of cause and effect statements. The first four lines correspond to the primary causes 10-16 referenced above. The following entries all correspond to intermediate effects, desired effects or effects to be explained. As can be seen, each effect can be expressed as statements of preceding causes joined by ORs and ANDs and NOTs. For example, the intermediate effect “Electrical Power” is caused by primary cause “Battery OK” or primary cause “Alternate Energy Source.” Likewise, intermediate effect “Starter Motor Runs” is caused by primary cause “Starter Motor OK” AND intermediate effect “Electrical Power.” Thus, the desired result “Car Starts” can quickly be seen as requiring both “Starter Motor Runs” AND “Spark Gets to Plugs.”

Further, a problem to be solved can also be represented as a Boolean expression of these statements. For example, it may be desirable to discover all possible causes for the observed effect of “Starter Motor Runs” AND NOT “Car Starts.” By substituting expressions, this observed effect can be represented as caused by “Alternate Electrical Source” AND NOT “Ignition Module OK” OR caused by “Battery OK” AND NOT “Ignition Module OK.” If “Alternative Electrical Source” OR “Battery OK” are true, this can be reduced to simply NOT “Ignition Module OK.”

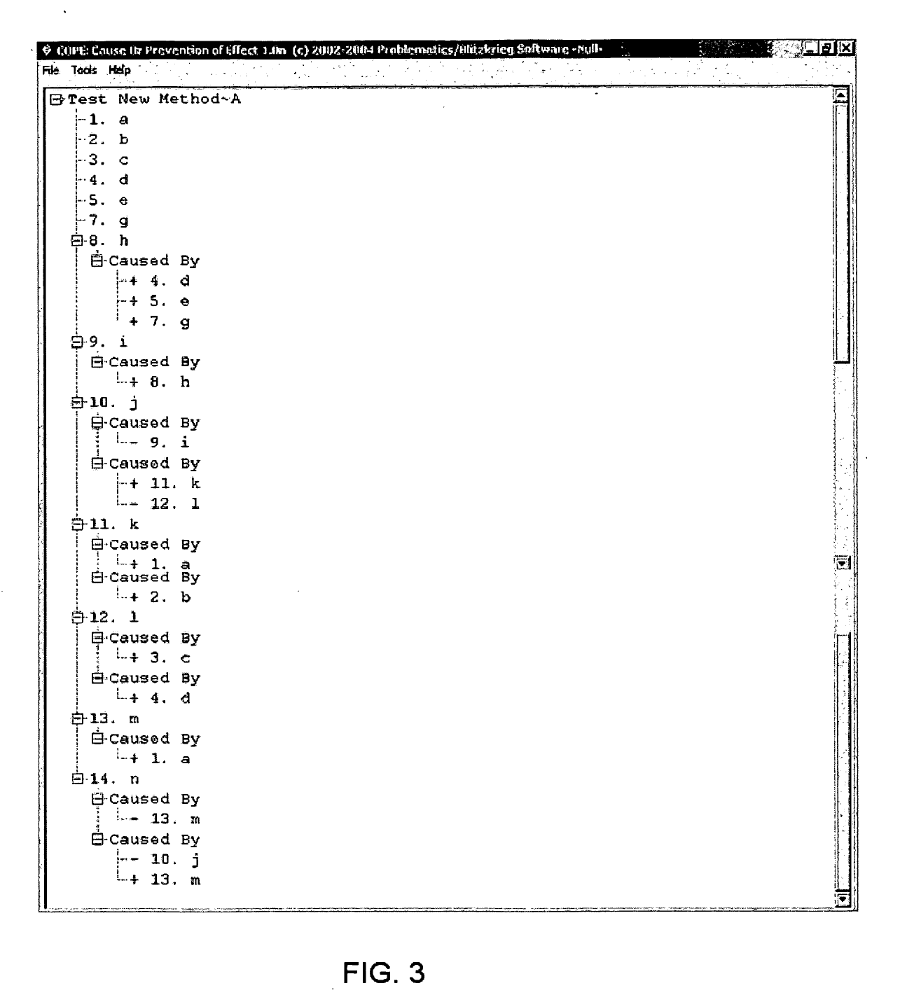

Further examples of how Boolean cause and effect statements can be represented diagrammatically are shown in FIGS. 3-15, in the context of demonstrating the methods of the invention to simplify the expressions. Turning first to FIG. 3, an exemplary system of cause and effect relations is shown as entered on a computer. The primary causes are statements a, b, c, d, e and g. Each intermediate effect h, i, j, k, l, and m is expressed as combinations of primary causes and other intermediate effects. Thus, intermediate effects can also function as causes for subsequent effects. Finally, n is the effect for which an explanation is desired. By following the methods of the invention, it is possible to express n solely as true or false in terms of hypotheses composed of the primary causes of the system. As discussed above, the outline level two represents alternative statements linked by the operator OR and outline level three represents statements linked by the operator AND. A “plus” sign indicates that the statement is unchanged while a “negative” sign indicates a NOT operation.

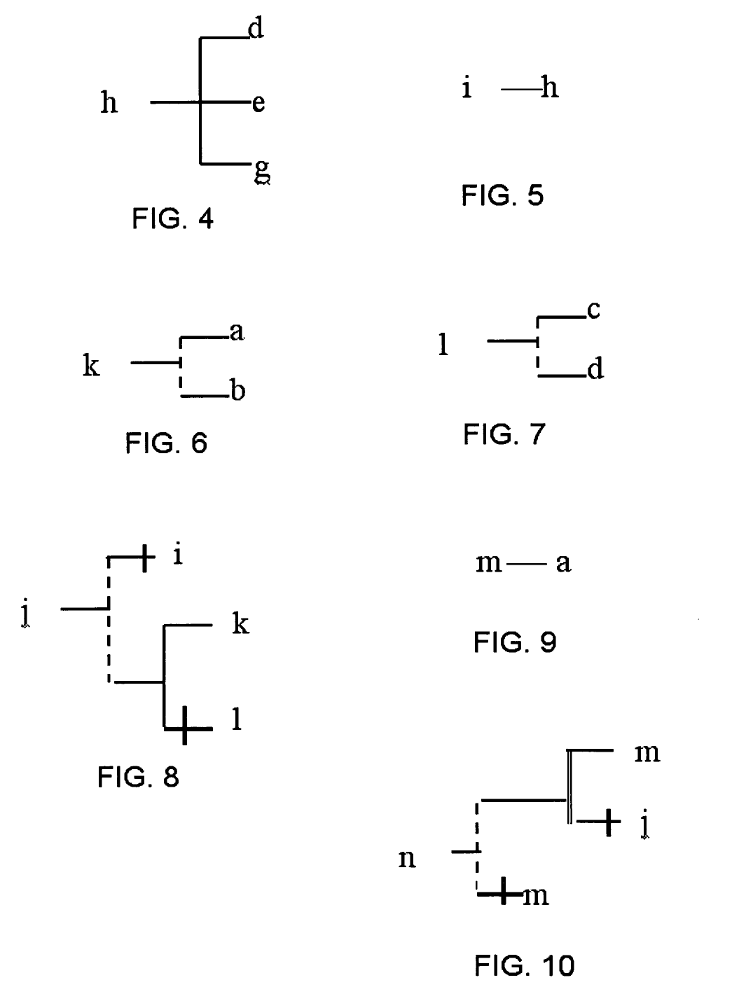

FIGS. 4-9 show how the intermediate effects from FIG. 3 can be represented diagrammatically, wherein a solid vertical bar represents the AND operator and a dashed vertical bar represents the OR operator. A vertical line through a horizontal connector indicates the NOT operator. FIG. 4 shows that intermediate effect h is caused by d AND e AND g. FIG. 5 shows that intermediate effect i is caused by h. FIG. 6 shows that intermediate effect k is caused by a OR b. FIG. 7 shows that intermediate effect l is caused by c OR d. FIG. 8 shows that intermediate effect j is caused by (NOT l) OR (k AND NOT l). FIG. 9 shows that intermediate effect m is caused by a.

FIG. 10 shows n, the desired effect, expressed as a combination of intermediate effects, specifically n is caused (m AND NOT j) OR NOT m.

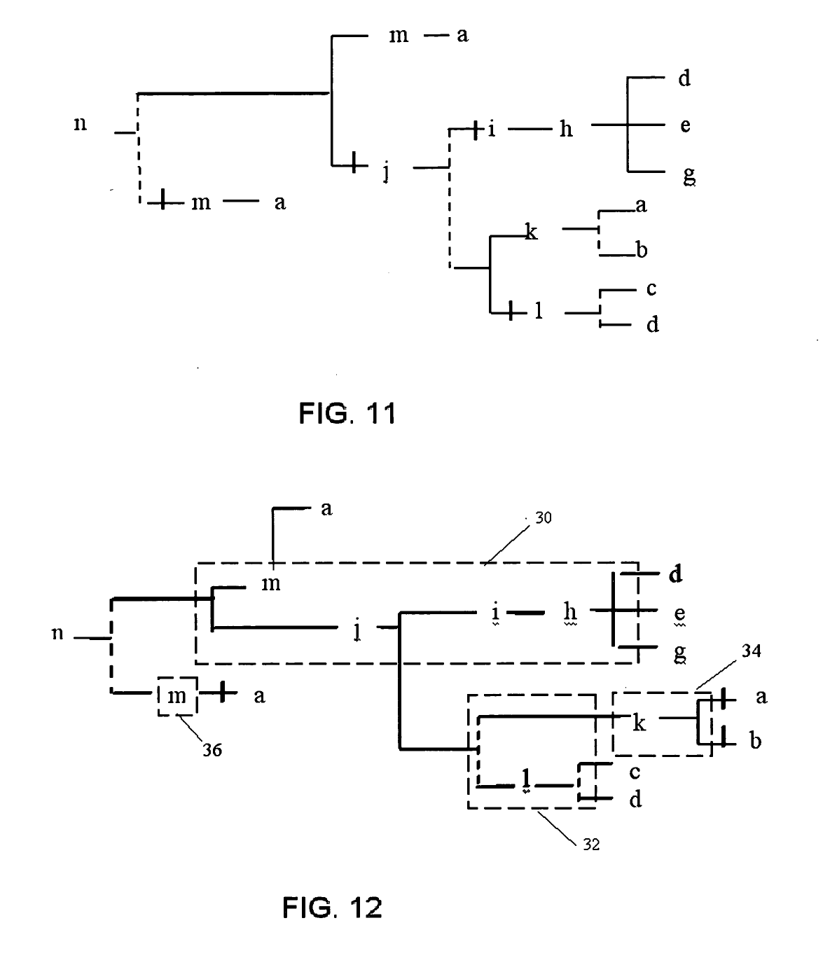

By putting FIGS. 4-10 together, n can be expressed as a combination of primary causes and intermediate effects as shown in FIG. 11. Following this diagram from right to left shows the causes leading to the effect n. Similarly, reading the diagram from left to right emphasizes the abductive nature of the logical framework, as the desired effect n is expressed in terms of all possible causes.

It would be possible to sequentially replace each intermediate effect with the corresponding combination of statements involving only primary causes using manipulations of Boolean rules analogous to the solving of simultaneous algebraic equations. However, this direct manipulation to eliminate intermediate effects generates significant redundancies with each operation. Since these redundancies build upon each other, this direct method rapidly becomes impractical once a system of any complexity is analyzed. As discussed below, an alternative embodiment of the invention eliminates the redundancies as they occur to permit the direct manipulation to proceed without becoming infeasible.

However, in another preferred embodiment of the invention, these redundancies are avoided by clustering Boolean operators. In this process, AND clusters are formed that contain no ORs, OR clusters are formed that contain no ANDs, and either type of cluster may or may not contain NOTs. Intermediate effects are first confined within clusters, then their internal relations are eliminated. By clustering, elimination is accomplished without the build up of redundancy during the process. Although some redundancy can occur in only the final answer, this can be eliminated at that time and no further processing steps cause that redundancy to build.

First, as shown in FIG. 12, the logical consequences of the NOT operators are extended from left to right, or from effect to cause. Whenever a NOT is encountered, AND bars becomes OR bars and OR bars become AND bars. Further, all the causes entering from the right are reversed in sign, specifically if there is no NOT operator, one is added and if a NOT operator is present, it is removed. This process is carried all the way through until the primary causes are reached. For example, the NOT m is caused by a portion of the diagram shown in FIG. 11 becomes m is caused by NOT a as shown in FIG. 12. Similarly, the NOT j shown in FIG. 11 is extended and changes the AND bar to an OR bar and is operated on intermediate effects k and l as shown in FIG. 12. Also shown in FIG. 12, the NOT j is extended until it reaches the NOT i shown in FIG. 11, canceling it out. As one having ordinary skill in the art will appreciate, this process is based on De Morgan's theorem.

Next, as also shown in FIG. 12, the AND operators and OR operators are clustered. Any remaining NOT operators are included within the respective clusters. AND clusters include the largest possible subset of AND bars and NOTs that can be connected without an intervening OR. For example, box 30 represents the AND cluster containing the intermediate effects m, j, i, h joined by ANDs and NOTs, and showing a, d, e, and g as external effects. Similarly, OR clusters include the largest possible subset of OR bars and NOT's that can be connected without an intervening AND. For example, box 32 represents the OR cluster containing the k OR l operation. Box 34 represents the AND cluster containing only k. Box 36 shows the cluster that contains only the m expression, since no other statements can be combined. This is a NULL operator having no replacement in the next figure. Finally, cluster externals are effects that have no further causes or effects within the cluster and are shown outside the boxes.

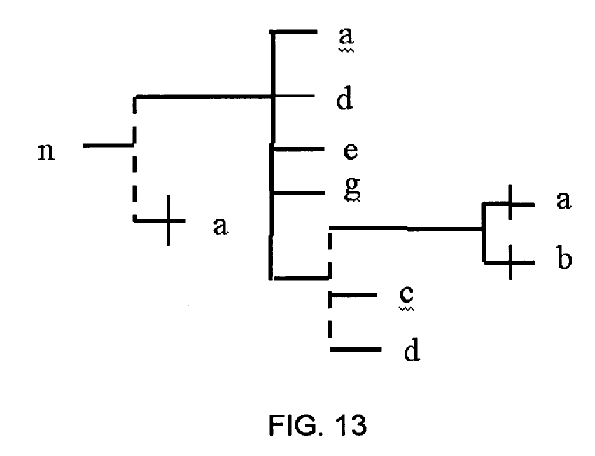

Each cluster shown in FIG. 12 is then replaced by a single bar corresponding to the type of cluster being replaced as shown in FIG. 13. The bar will have entering from the right those external effects that entered the cluster from the right. The bar will have exiting from the left those external effects that exited the cluster to the left. All effects completely internal to the cluster are eliminated. Thus, in FIG. 13, box 30 has been replaced by an AND operator, box 32 has been replaced by an OR operator, box 34 has been replaced by an AND operator, and box 36 has been replaced by a NULL operator.

FIG. 13 also demonstrates that all intermediate effects have been eliminated and n is expressed solely as statements of primary causes. Since the intermediate effects have been eliminated, the final step of the process is to recognize and remove any redundancies. As can be appreciated by those having skill in the art, the Boolean rules among others used to remove redundancies are:

(1) (u OR v) AND u=u

and (2) (u OR v) AND NOT u=v

[image]

Additional rules used in the practice of the invention include substitutions, identities and De Morgan's rules, which are applied in conventional manners known to those having skill in the art.

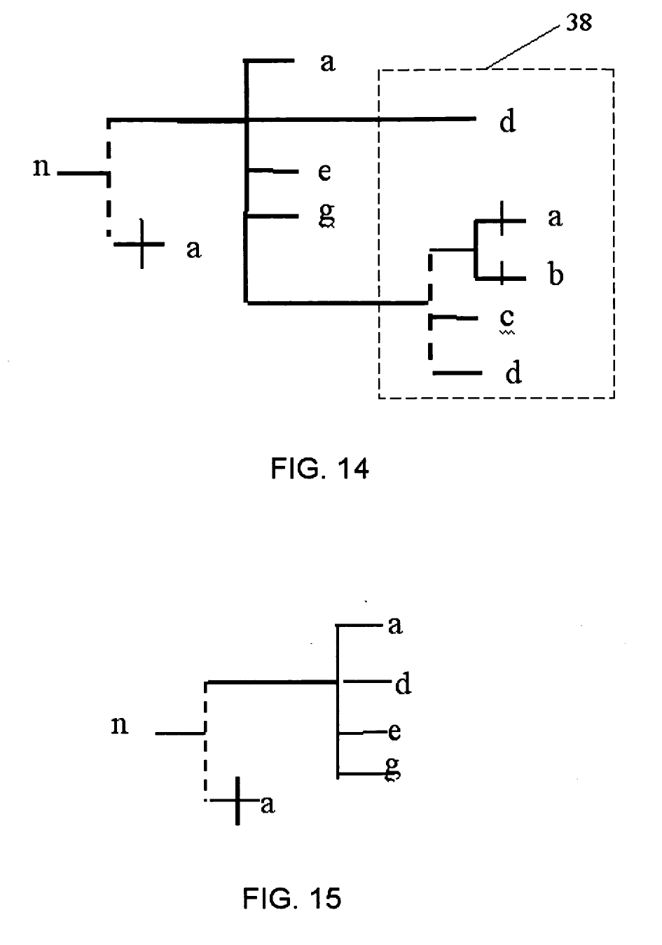

As shown in FIG. 14, box 38 indicates a redundancy because the cause d is the subject of an AND operator and an OR operator. By applying rule (1) shown above, box 38 can be replaced with the statement d alone, as shown in FIG. 15. This shows that n can be expressed as (NOT a) OR (a AND d AND e AND g) after application of the methods of the invention.

In one embodiment of the invention, the method is implemented on a computer programmed with instructions representing the steps discussed above. Preferably, a scanning process is used to find the clusters.

For example, an initial scan begins having the effect to be explained as its root. In situations in which the behavior to be explained is a Boolean expression, an artificial beginning effect can be added having that Boolean expression as its cause.

In a scan for contiguous ANDs and NOTs, the scan retreats when it confronts an OR unless a NOT operation has converted the OR into an AND. An external connector is recorded so that it can later be used to tie together the AND and NOT clusters with the OR and NOT clusters. Similarly, in a scan for contiguous ORs and NOTs, the scan retreats when it confronts an AND unless a NOT operation has converted the AND into an OR. A connector is recorded so that it can later be used to tie together the AND and NOT clusters with the OR and NOT clusters.

The scan of a cluster terminates when the scan returns to the root and there are no more branches from that root to be scanned. When a scan of a cluster has terminated, the scan picks up a connector that has not yet been scanned to be used as a root for a new scan.

The scanning terminates when there are no further connectors left to be scanned. Once the scanning is complete, the AND clusters and OR clusters are tied together by their connectors to produce the hypotheses. As described above, Boolean rules are used to remove any redundancies that occur as a result of the previous step. Preferably, this is the only stage of the process where redundancy needs to be addressed. The result of this stage is the desired answer.

In an alternative implementation, an AND scan retreats when it encounters either an OR or a NOT. An OR scan retreats when it encounters either an AND or a NOT. Consideration of the NOTs is delayed and later handled in the process of stitching the clusters together.

In another embodiment of the invention, each intermediate effect is sequentially replaced with the corresponding combination of statements involving only primary causes as described above. This replacement process can produce redundancies. Since these redundancies build upon each other, this direct method rapidly becomes impractical once a system of any complexity is analyzed. Using the methods of the invention, the redundancies are removed as they occur to prevent them from operating on each other and keep the computation feasible.

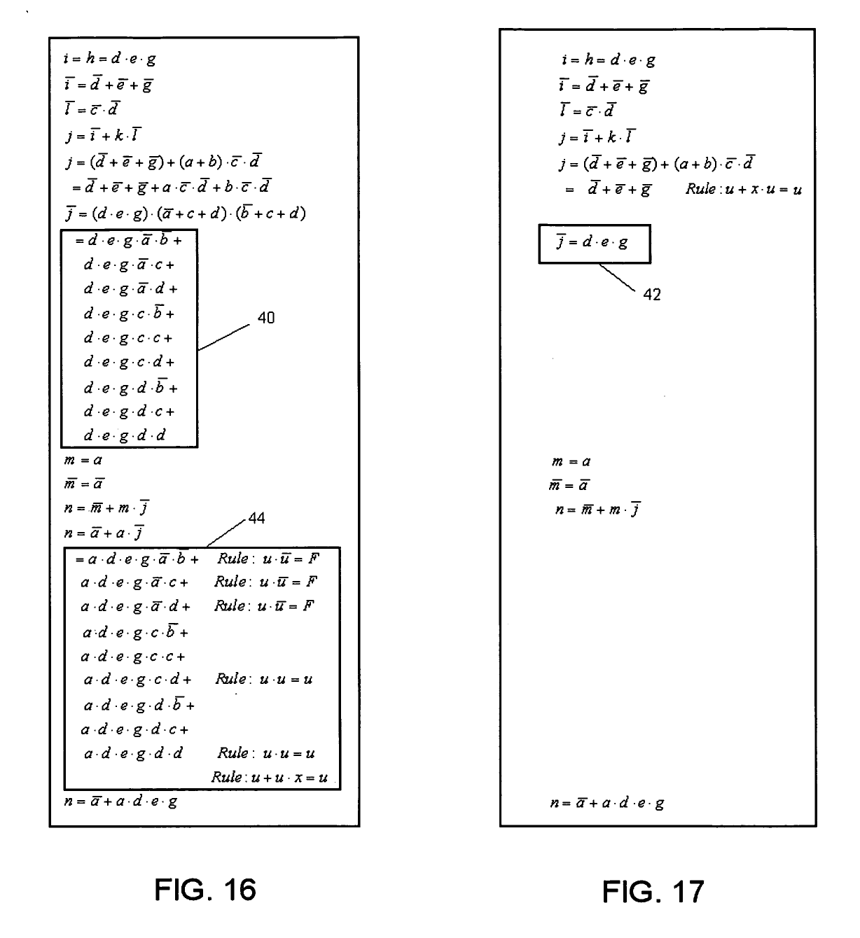

Turning now to FIGS. 16 and 17, two processes are shown involving the direct substitution of Boolean expressions to simplify a desired expression so that it may be expressed solely in terms of primary causes. The noted processes use the system of cause and effect statements shown in FIG. 3. In these figures, the “+” notation denotes the OR operator, the “·” notation denotes the AND operator and a bar over the effect denotes the NOT operator. In FIG. 16 redundancies develop that are subjected to subsequent operations and lead to a relatively complicated process. In contrast, FIG. 17 shows a process in which the redundancies are removed as they occur, preventing the redundancies from being operated on by subsequent operations. As can be seen, the process exemplified by FIG. 17 can require far less computation power.

For example, the series of equations in box 40 shown in FIG. 16 can be replaced by the equation shown in box 42 of FIG. 17 by noting that the last expression in the box, d·e·g·d·d, is equal to d·e·g by the rule u·u=u. The remaining expressions in the box are eliminated by the rule u+u·v=u. The redundancies in box 44 are removed by the same rules. As can readily be appreciated, far more computation is required if redundancies are not removed. The difference in the number of operations between not removing redundancies as they occur and removing redundancies as they occur grows dramatically as the size of the problem increases.

In general, the methods of the invention can be performed by identifying and removing redundancies as they occur during the Boolean substitutions using primarily Rules (1) and (2) described above.

In one aspect of the invention, the plurality of cause and effect statements used to describe a system can be stored in a database. Preferably, any number of individuals at one or more locations can generate and update the database, effectively pooling their knowledge. As described above, the steps of the invention can then be used to express a given effect as a Boolean statement of the primary causes of the system.

Using the methods of the invention, a wide variety of problems can be solved. Similarly, the concepts of the invention can be used in a wide variety of applications.

As described above, this method can use a set of cause and effect statements that describe a system to find the explanations for particular behaviors of that system. In one embodiment, these features can be implemented in a machine for troubleshooting, diagnostic and control purposes.

Given a set of cause and effect statements describing a system, then given a behavior of said system described by a Boolean expression on the effects, this invention can be used to find all the hypotheses composed of Boolean expressions on the primary causes that within the scope of the cause and effect statements would yield the given behavior. A behavior can be composed of effects joined by ANDs, ORs and NOTs.

Further, given a hypothesis, this method can use the cause and effect statements and deduction to predict all the behaviors of the system caused by the hypothesis. The predicted behavior may also include side effects, i.e. behaviors in addition to the behavior that was to be explained.

Given a set of cause and effect statements describing a system and a hypotheses, one having skill in the art will appreciate that all the behaviors of said system under said hypothesis can be predicted, such behaviors being made up of the behavior being explained and possibly side effects not requested to be explained.

Analysis of the side effects can be used to reject a potential hypothesis if the predicted side effects are deemed not to be True. In one embodiment, all the hypotheses having harmful side effects are also eliminated.

The methods of the invention can also be used to produce scenarios by keeping all the intermediate steps.

This same method can be used to design systems by interpreting these cause and effect statements such as for example: I can do THIS if I can do (THAT₁ and THAT₂) or THAT₃.

In another application of the invention, given the hypotheses that explain a desired behavior, the causes that make up any hypothesis can be implemented to achieve the desired behavior. Conversely, by finding hypotheses and scenarios for how the given behavior could happen, each scenario can be prevented from happening by preventing any one of the effects in the scenario from occurring. Often the scenarios from different hypotheses share one or more effects so that by preventing one of these common effects all the said scenarios can be prevented.

In a further aspect of the invention, after the method of the invention has been applied to give the discrete structure of the system, quantitative values can be attached to the statements to help make quantitative calculations. Preferably, numerical variables related to these statements can include probabilities or magnitudes of effects or durations. Other numerical values can also be used as desired

As described above, the methods of the invention can be used to develop a scenario for a hypothesis that explains what is to be accomplished. The scenario can be extended by relating durations and precedence sequences to develop a plan. The precedence order given by the scenario is often, but not always, the precedence order that can be used for the plan.

By providing cause and effect relations for capabilities of available resources, and explanation for the requirement specifications, a hypothesis can be chosen and its causes implemented to produce an invention. Preferably, multiple behaviors can be joined by ORs. Each hypothesis is composed of causes joined with ANDs and multiple hypotheses are separated into different hypotheses by ORs, wherein the hypotheses are all those possible within the scope of said set of cause and effect statements.

Scientific investigation can be done by making up a set of cause and effect statements describing what is already believed about a system, then asking for an explanation of what one observes. If by extension or modification it can be explained within the scope of the set of cause and effect statements, then the causes make up hypotheses. Each hypothesis is rejected if it explains side effects that are deemed to be false.

As can be appreciated, in the embodiments of the invention implemented on a computer, one or more people can collaborate in developing the set of cause and effect statements. Further, such embodiments can be updated remotely. As discussed above, this allows a system to be described and developed incrementally, using the contribution of information from many people and many sources. Accordingly, these methods represent a considerable advantage over conventional expert systems, which generally require a single expert to construct the system, whose knowledge may not be complete.

Described herein are presently preferred embodiments, however, one skilled in the art that pertains to the present invention will understand that there are equivalent alternative embodiments. As such, changes and modifications are properly, equitably, and intended to be, within the full range of equivalence of the following claims.

What is claimed is:

1. A method for solving a problem comprising the steps of:
a) providing a closed system of a plurality of cause and effect statements, wherein the plurality of statements exhibit equivalency relationships and wherein the plurality of statements comprise primary causes, intermediate effects and at least one desired effect;
b) expressing the desired effect as true or false in relationship to the primary causes and intermediate effects;
c) representing the plurality of cause and effect statements as a plurality of simultaneous Boolean expressions;
d) simplifying the simultaneous Boolean expressions by substituting expressions using primary causes to eliminate expressions using intermediate effects; and
e) expressing the desired effect as true or false in relation only to the primary causes.

2. The method of claim 1, wherein the step of simplifying the simultaneous Boolean expressions comprises identifying a cluster of identical Boolean operators within the expressions that comprise the intermediate effects and replacing the cluster with a single Boolean operator.

3. The method of claim 2, wherein the step of simplifying the simultaneous Boolean expressions comprises identifying a plurality of clusters of identical Boolean operators within the expressions that comprise the intermediate effects and replacing the cluster with a single Boolean operator, wherein each cluster comprises either AND and NOT operators or OR and NOT operators.

4. The method of claim 3, wherein the step of simplifying the simultaneous Boolean expressions further comprises implementing NOT operators by, in the effect to cause direction:
a) changing each AND operator to an OR operator;
b) changing each OR operator to an AND operator;
c) adding a NOT operator if one does not exist; and
d) removing a NOT operator if one does exist.

5. The method of claim 4, wherein the step of expressing the desired effect as true or false in relation only to the primary causes further comprises identifying and removing redundancies with Boolean algebra.

6. The method of claim 1, wherein the step of simplifying the simultaneous Boolean expressions comprises substituting an expression comprising an intermediate effect with an expression comprising only primary causes.

7. The method of claim 6, further comprising the step of removing any redundancies after substituting an expression comprising only primary causes for an expression comprising an intermediate effect.

8. The method of claim 7, further comprising the step of performing a subsequent substitution of an expression comprising an intermediate effect with an expression comprising only primary causes.

9. The method of claim 1, wherein the step of expressing the desired effect as true or false in relation only to the primary causes identifies all hypotheses expressed by primary causes that lead to the desired effect in the closed system.

10. A data processing system comprising:
a) a memory containing a closed system of a plurality of cause and effect statements, wherein the plurality of statements exhibit equivalency relationships and wherein the plurality of statements comprise primary causes, intermediate effects and at least one desired effect, wherein the plurality of cause and effect statements are represented as a plurality of simultaneous Boolean expressions and wherein the desired effect is expressed as true or false in relationship to the primary causes and intermediate effects; and
b) an abducing processor configured to simplify the simultaneous Boolean expressions by substituting expressions using primary causes to eliminate intermediate effects and express the desired effect as true or false in relation only to the primary causes.

11. The data processing system of claim 10, wherein the abducing processor is configured to identify a cluster of identical Boolean operators within the expressions that comprise the intermediate effects and replace the cluster with a single Boolean operator.

12. The data processing system of claim 11, wherein the abducing processor is configured to identify a plurality of clusters of identical Boolean operators within the expressions that comprise the intermediate effects and replace the cluster with a single Boolean operator, wherein each cluster comprises either AND operators or OR operators.

13. The data processing system of claim 12, wherein the abducing processor is configured to identify and remove redundancies with Boolean algebra.

14. The data processing system of claim 10, wherein the abducing processor is configured to substitute an expression comprising an intermediate effect with an expression comprising only primary causes.

15. The data processing system of claim 14, wherein the abducing processor is further configured to remove any redundancies after substituting an expression comprising only primary causes for an expression comprising an intermediate effect.

16. The data processing system of claim 15, wherein the abducing processor is further configured to perform a subsequent substitution of an expression comprising an intermediate effect with an expression comprising only primary causes.

17. The data processing system of claim 10, wherein the abducing processor is configured to express the desired effect as true or false in relation only to the primary causes identifies all hypotheses expressed by primary causes that lead to the desired effect in the closed system.
